(19) United States
(12) Patent Application Publication
(10) Pub. No.: US 2012/0114182 A1
(43) Pub. Date: May 10, 2012

(54) METHOD AND APPARATUS FOR MEASURING DEPTH OF FIELD

(75) Inventor: Yung-Hsin LIU, Taipei County (TW)

(73) Assignee: Quanta Computer Inc., Tao Yuan Shien (TW)

(21) Appl. No.: 12/987,307

(22) Filed: Jan. 10, 2011

(30) Foreign Application Priority Data
Nov. 4, 2010 (TW) 99138020

(51) Int. Cl. G06K 9/60

(52) U.S. Cl. 382/106

(57) ABSTRACT

A method and an apparatus for measuring a depth of field (DOF) are disclosed. The DOF measuring method includes the following steps. Firstly, an image is captured in each of a plurality of focus scales respectively, wherein each image respectively includes an image region corresponding to the same image area. Next, one of the image regions is selected as the best DOF region. Then, a DOF value corresponding to the focus scale corresponding to the best DOF image region is determined according to a lookup table.

This application claims the benefit of Taiwan application Serial. No. 99138020, filed Nov. 4, 2010, the subject matter of which is incorporated herein by reference.

### BACKGROUND OF THE INVENTION

1. Field of the Invention

The invention relates in general to a measuring apparatus, and more particularly to a method and an apparatus for measuring a depth of field (FOD).

2. Description of the Related Art

Referring to both FIG. 1 and FIG. 2. FIG. 1 shows an image sensor, an infra-red sensor and an infra-red light source. FIG. 2 shows a distribution of wavelength of visible light and invisible light. The conventional method for measuring the distance of an object and the DOF requires the use of an image sensor 11, an infra-red sensor 12 and an infra-red light source 13. The image sensor 11 is for recognizing the visible light to capture a color image 51. The image sensor 11 is such as a Bayer sensor, and the wavelength range of the visible light is such as Δλ1. The infra-red light source 13 emits an infra-red light to an object, and the infra-red sensor 12 receives an infra-red light reflected from the object to generate a depth image S2. The infra-red sensor 12, for example, calculates the distance of the object according to the travelling time of the infra-red light reflected from the object so as to generate the depth image S2. The infra-red sensor 12 is used for recognizing the invisible light, and the wavelength range of the invisible light is such as Δλ2.

The conventional method uses an infra-red sensor and an infra-red light source to project an infra-red light, not only consuming more power and incurring more cost but also jeopardizing market competiveness.

### SUMMARY OF THE INVENTION

The invention is directed to a method and an apparatus for measuring a depth of field (FOD).

According to a first aspect of the present invention, a DOF measuring method is disclosed. The DOF measuring method includes the following steps. Firstly, an image is captured in each of a plurality of focus scales respectively, wherein each image respectively includes an image region corresponding to the same image area. Next, one of the image regions is selected as the best DOF region. Then, a DOF value corresponding to the focus scale corresponding to the best DOF image region is determined according to a lookup table.

According to a second aspect of the present invention, a DOF measuring apparatus is disclosed. The DOF measuring apparatus includes an image sensor, a selection unit, a lookup table unit and a storage unit. The image sensor captures an image in each of a plurality of focus scales respectively, wherein each image respectively includes an image region corresponding to the same image area. The selection unit selects one of the image regions as the best DOF image region. The lookup table unit determines a DOF value corresponding to the focus scale corresponding to the best DOF image region according to a lookup table. The storage unit stores the lookup table.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows an image sensor, an infra-red sensor and an infra-red light source;

FIG. 2 shows a distribution of wavelength of visible light and invisible light;

FIG. 3 shows an image sensor;

FIG. 4 shows a DOF table;

FIG. 5 shows a partial enlargement of FIG. 4;

FIG. 6 shows a block diagram of a DOF measuring apparatus according to a first embodiment of the invention;

FIG. 7 shows a flowchart of a DOF measuring method according to a first embodiment of the invention;

FIG. 8 shows an image sensor capturing an image in each focus scale;

FIG. 9 shows the sharpness of a plurality of image regions corresponding to the same image area;

FIG. 10 shows a block diagram of a DOF measuring apparatus according to a second embodiment of the invention; and

FIG. 11 shows a flowchart of a DOF measuring method according to a second embodiment of the invention.

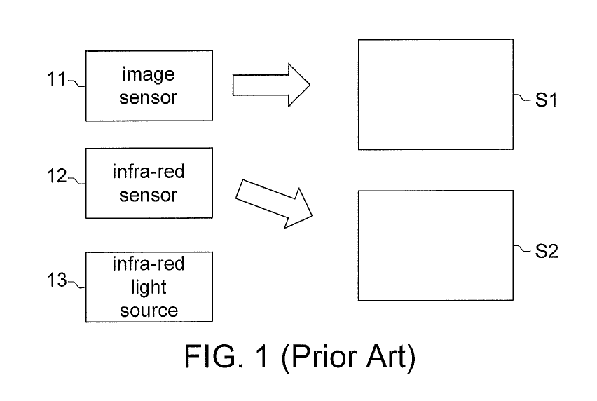

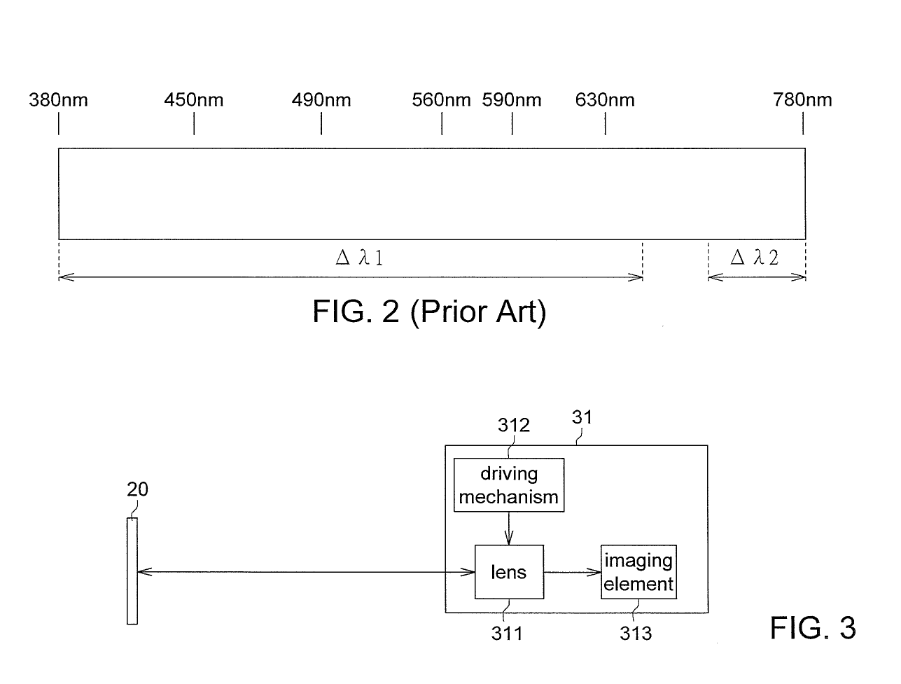

### DETAILED DESCRIPTION OF THE INVENTION

### First Embodiment

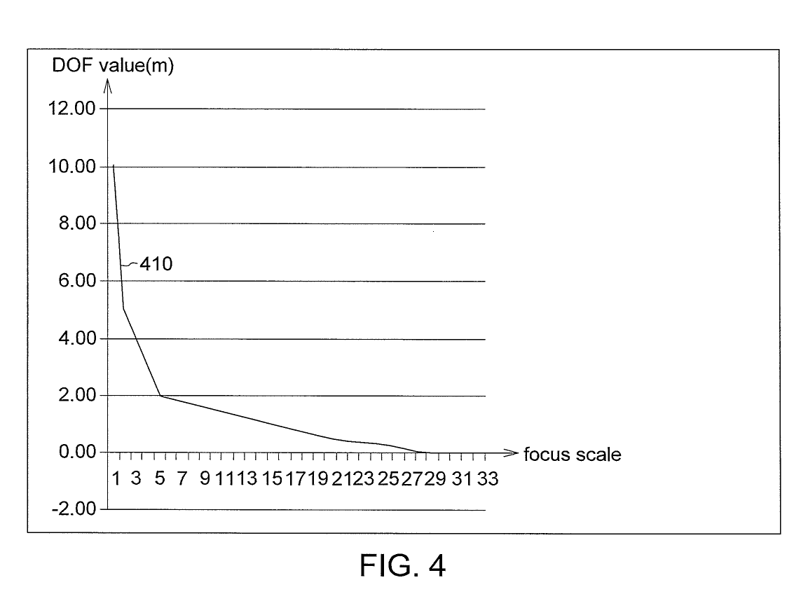

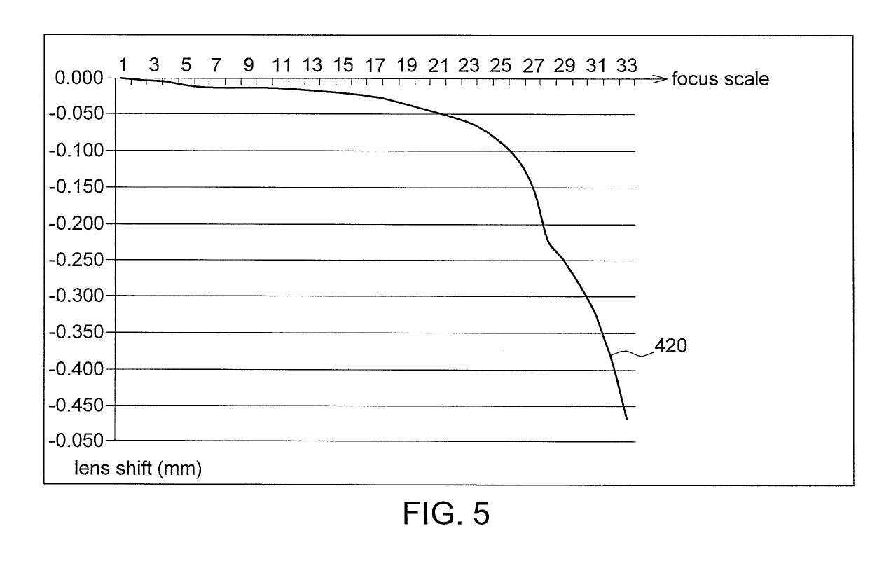

Referring to FIG. 3, FIG. 4 and FIG. 5. FIG. 3 shows an image sensor. FIG. 4 shows a DOF table. FIG. 5 shows a partial enlargement of FIG. 4. The image sensor 31, realized by such as a Bayer sensor, includes a lens 311, a driving mechanism 312 and an imaging element 313. The image sensor 31 is used for capturing the image of an object 20. The driving mechanism 312 is realized by such as a step motor. The imaging element 313 is realized by such as a charge coupled device (CCD) or a complementary metal-oxide-semiconductor (CMOS). The DOF value curve 410 denotes the correspondence between the depth of field (DOF) value and the focus scale. The lens shift curve 420 denotes the correspondence between the lens shift and the focus scale.

The driving mechanism 312 of the image sensor 31 adjusts the lens shift in different focus scales to capture the image of the object 20. The focus scale is also referred as the focusing step. Different DOF values are generated as the focus scale changes. The DOF value refers to a certain distance between the object 20 and the lens 311 within which the object image on the imaging element 311 still remains clear.

For example, if the focus scale equals 1, the DOF is about 10 m. Meanwhile, if the distance between the lens 311 and the object 20 is 10 m, then the object image on the imaging element 313 remains clear. Similarly, if the focus scale equals 5, the DOF is about 2 m. Meanwhile, if the distance between the lens 311 and the object 20 is 2 m, then the object image on the imaging element 313 remains clear. For convenience of elaboration, the focus scales are denoted by 1˜33 in FIG. 4 and FIG. 5. However, the number of focus scales can adapt to the design of the image sensor 31.

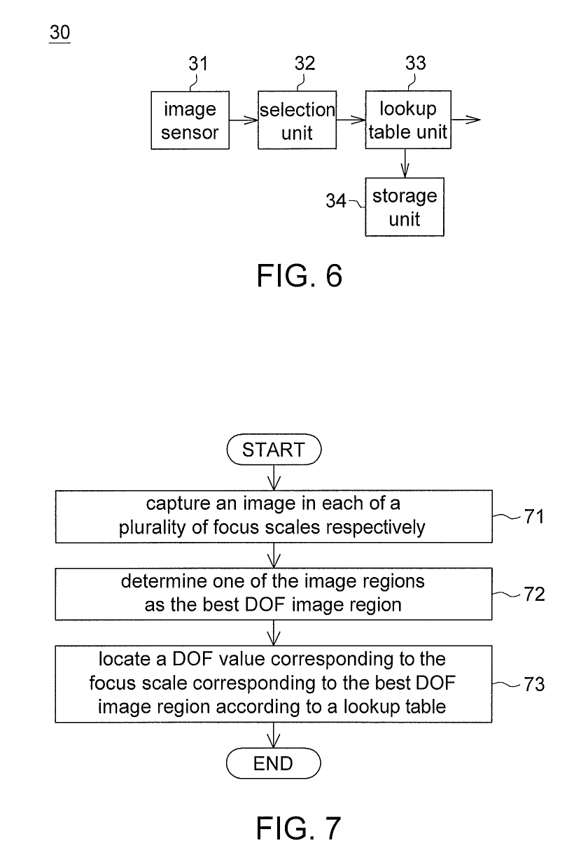

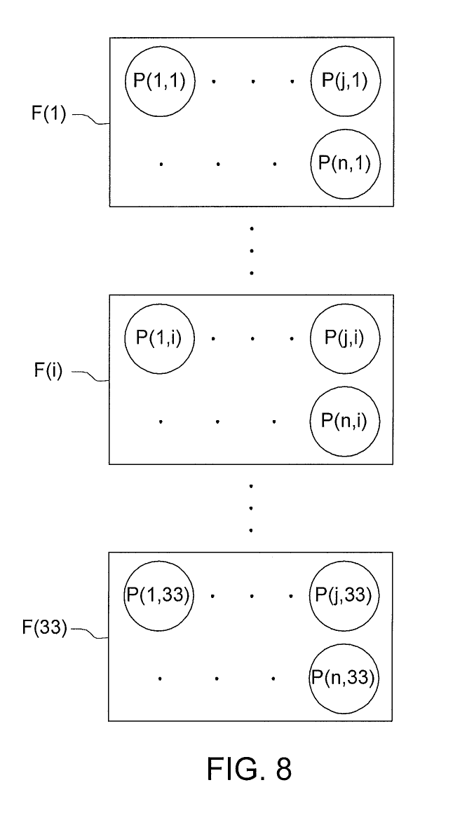

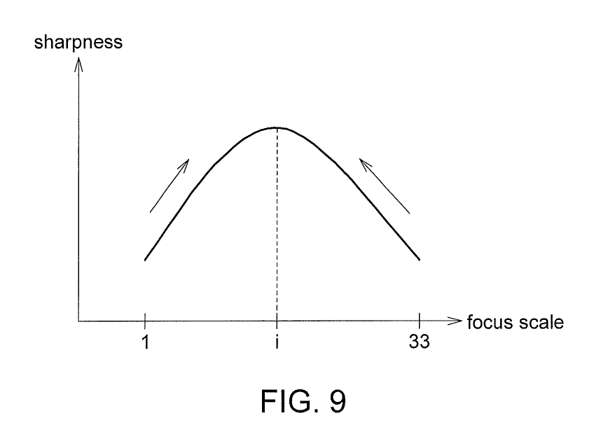

Referring to FIG. 6, FIG. 7, FIG. 8 and FIG. 9. FIG. 6 shows a block diagram of a DOF measuring apparatus according to a first embodiment of the invention. FIG. 7 shows a flowchart of a DOF measuring method according to a first embodiment of the invention. FIG. 8 shows an image sensor capturing an image in each focus scale. FIG. 9 shows the sharpness of a plurality of image regions corresponding to the same image area. The DOF measuring apparatus 30 includes an image sensor 31, a selection unit 32, a lookup table unit 33 and a storage unit 34. The image sensor 31 is realized by such as a Bayer sensor. The storage unit 34 used for storing the lookup table is realized by such as a memory. The selection unit 32 and the lookup table unit 33 are realized by a processor performing an algorithm. The lookup table is such as the DOF table of FIG. 4 and FIG. 5.

The DOF measuring method includes the following steps. Firstly, the method begins at step 71, an image is respectively captured in each focus scale by the image sensor 31. For convenience of elaboration, the focus scales are exemplified by focus scales 1˜33, thus 33 images are generated accordingly. The 33 images are exemplified by the first image F(1) to the 33^{th} image F(33) illustrated in FIG. 8, wherein the i^{th} image F(i) denotes the image captured in the i^{th} focus scale, and i is a positive integer ranging between 1˜33.

Each of the 33 images includes the same number of image regions (i.e. each image is segmented into several image regions), such as, n image regions, wherein n is a positive integer not equal to 0, and the image region could be defined as a single pixel or a pixel block containing a plurality of pixels. For example, the first image F(1) includes n image regions P(1,1)˜P(n,1), wherein the first number in the parenthesis denotes the n^{th} image region, and the second number in the parenthesis denotes the i^{th} image, and i=1 in the present example. Similarly, the i^{th} image F(i) includes n image regions P(1,i)˜P(n,i), and the 33^{rd} image F(33) includes n image regions P(1,33)˜P(n,33). The image regions with the same designation or number correspond to the same image area of the image. For example, from the first image region of the first image P(1,1) to the first image region of the 33^{rd} image P(1,33), all first image regions correspond to the same image area (i.e., the left-top position in the present example). Likewise, all of the j^{th} image regions correspond to the same image area, and so do all of n^{th} image regions of the first image P(n,1) to the n^{th} image region of the 33^{rd} image P(n,33) correspond to the same image area (i.e., the right-bottom position in the present example).

Next, the method proceeds to step 72. In step 72, the selection unit 32 selects the image with best DOF from the 33 images F(1)˜F(33) corresponding to the same image area, that is, the image region with the highest sharpness level is selected from the image regions, corresponding to the same image area, of the 33 images whose image regions. For example, the image regions corresponding to the image area at the left-top corner (the first image area) include the first image region of the first image P(1,1), the first image region of the second image P(1, 2) to the first image region of the 33^{rd} image P(1,33). Suppose the image region P(1,1) to the image region P(1,33) respectively have a sharpness whose distribution is illustrated in FIG. 9, wherein the horizontal axis denotes the focus scale. In other words, the horizontal axis respectively denotes the image regions P(1,1)˜P(1,33) of the images F(1)˜F(33) due to the images F(1)˜F(33) are captured with different focus scales as described above. As indicated in FIG. 9, if the first image region of the i^{th} image P(1,i) has the highest sharpness level among all image regions (i.e., the image regions P(1,1)˜P(1,33)) corresponding to the first image area, then the i^{th} image is selected as the best DOF image region among all image regions corresponding to said image area. Thus, the selection unit 32 selects the first image region of the i^{th} image P(1,i) as the best DOF image region corresponding to the first image area. Similarly, the best DOF regions for other image areas can be determined in the same manner.

Then, the method proceeds to step 73. In step 73, the lookup table unit 33 determines the DOF value corresponding to the i^{th} focus scale according to the lookup table (FIG. 4) stored in the storage unit 34, wherein the lookup table is obtained according to the DOF table. As disclosed above, different focus scales correspond to different DOF values, in the embodiment the DOF value corresponding to the image region P(1,i) can be determined from the lookup table. For example, if i equals 5 (that is, the fifth image), due to the image is captured in the fifth focus scale, and it can be inferred from the DOF value stored in the storage unit 34 that the DOF value of the fifth focus scale equals 2 m. In other words, the DOF value of the first image area equals 2 m. Likewise, with respect to selecting the best DOF region from the 33 images for each image area, since each image corresponds to a focus scale, the DOF value corresponding to the focus scale can be obtained from the DOF table. Thus, the DOF values of all image areas of the image can be obtained accordingly.

### Second Embodiment

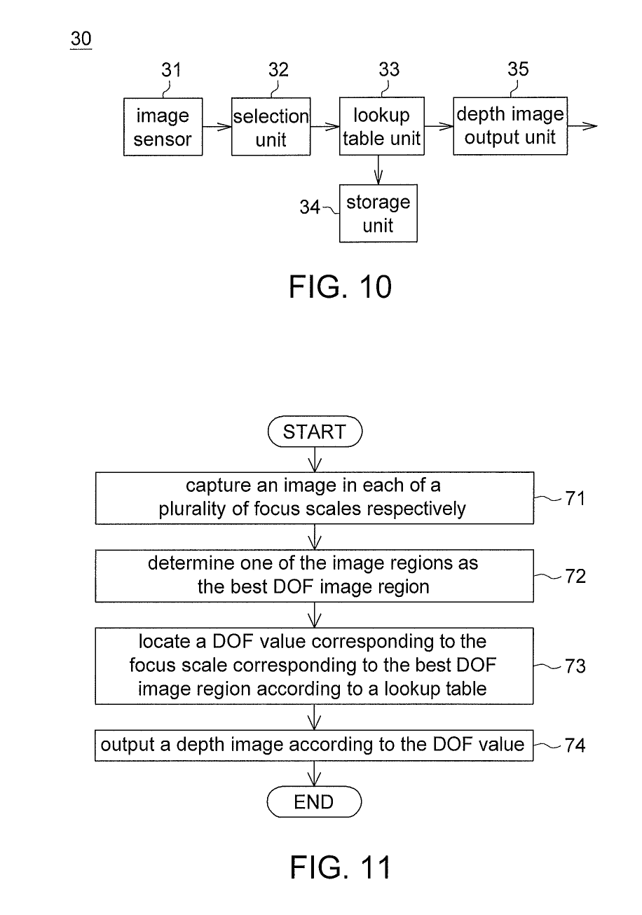

Referring to both FIG. 10 and FIG. 11. FIG. 10 shows a block diagram of a DOF measuring apparatus according to a second embodiment of the invention. FIG. 11 shows a flowchart of a DOF measuring method according to a second embodiment of the invention. The DOF measuring apparatus 50 is different from the DOF measuring apparatus 30 mainly in that the DOF measuring apparatus 50 further includes a depth image output unit 35 in addition to the image sensor 31, the selection unit 32, the lookup table unit 33 and the storage unit 34. The depth image output unit 35 is realized by a processor performing an algorithm. The DOF measuring method of the second embodiment further includes step 74 in addition to steps 71 to 73.

After step 73 is completed, the method proceeds to step 74. In step 74, a depth image is outputted by the depth image output unit 35 according to the DOF value. Since respective DOF value corresponding to each image area is obtained by performing steps 71 to 73, the image output unit 35 can further generate the required DOF image according to the DOF depths without using extra infra-red light source or infra-red sensor.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A depth of field (FOD) measuring method, comprising:
capturing an image in each of a plurality of focus scales respectively, wherein each image respectively comprises an image region corresponding to the same image area;
selecting one of the image regions as best DOF image region; and
determining a DOF value corresponding to the focus scale corresponding to the best DOF image region according to a lookup table.

2. The DOF measuring method according to claim 1, wherein each image region has a sharpness level, and the best DOF image region has the highest sharpness level among all image regions.

3. The DOF measuring method according to claim 1, wherein each image region is a pixel.

4. The DOF measuring method according to claim 1, wherein each image region is a pixel block.

5. The DOF measuring method according to claim 1, wherein the lookup table is obtained according to a DOF table.

6. The DOF measuring method according to claim 1, further comprising:
generating a depth image according to the DOF value.

7. A DOF measuring apparatus, comprising:
an image sensor used for capturing an image in each of a plurality of focus scales respectively, wherein each image respectively comprises an image region corresponding to the same image area;
a selection unit used for selecting one of the image regions as best DOF image region;
a lookup table unit used for determining a DOF value corresponding to the focus scale corresponding to the best DOF image region according to a lookup table; and
a storage unit used for storing the lookup table.

8. The DOF measuring apparatus according to claim 7, wherein each image region has a sharpness level, and the best DOF image region has the highest sharpness level among all image regions.

9. The DOF measuring apparatus according to claim 7, wherein each image region is a pixel.

10. The DOF measuring apparatus according to claim 7, wherein each image region is a pixel block.

11. The DOF measuring apparatus according to claim 7, wherein the lookup table comprises a DOF table.

12. The DOF measuring apparatus according to claim 7, further comprising:
a depth image output unit used for outputting a depth image according to the DOF value.
